(19) United States
(12) Patent Application Publication
(10) Pub. No.: US 2004/0149899 A1
(43) Pub. Date: Aug. 5, 2004

(54) Portable light detector

(76) Inventors: Andrew Packman, Reading (GB); Rhys Lewis, Appleton (GB); Michael Long, Didcot (GB)

Correspondence Address: SIEBERTH & PATTY, 2924 BRAKLEY DRIVE SUITE A 1, BATON ROUGE, LA, 70816

(21) Appl. No.: 10/473,185

(22) PCT Filed: Mar. 26, 2002
(86) PCT No.: PCT/GB02/01440

(30) Foreign Application Priority Data
Mar. 26, 2001 (GB) 0107532.4

(51) Int. Cl. G01N 21/64

(52) U.S. Cl. 250/239; 422/82.08; 422/61

(57) ABSTRACT

The present invention provides a portable luminometer for detecting very low light levels. The detector includes a sensor arranged to measure light emission from a sample contained in a housing of the detector. The sample is input through a port having a lid. The lid includes a member arranged to prevent the transmission of all exterior light to the sensor when the sample is being measured.

The present invention relates to a portable light detector for conducting light measurements upon a sample. The invention further relates to a method of manufacturing the portable light detector. The. light detector is particularly suitable for conducting light measurements on liquid samples, such as water toxicity measurements.

The light sensor provided by the present invention are particularly suitable for detecting very low levels of light from a measurement cell within the detector. In particular, the present invention relates to portable light detectors which can be used to conduct tests in the field, for example in taking water samples from rivers to measure the toxicity therein. The present invention shall be explained principally in relation to such test regimes, but the principles of the invention are equally applicable to all fields where low level light detection is required.

The determination of the toxicity level in a sample is clearly important. In natural water courses such as streams and rivers, the toxicity level will vary greatly from place to place and also depend upon the particular climatic and seasonal variations which occur in the locality. The number and the nature of pollutants is enormous. Each individual pollutant can be tested in a traditional laboratory environment using chromatographic methods and other assay techniques. This is however expensive and time consuming especially when the full range of pollutants is not known prior to testing.

The portable light detectors of the present invention are used for measuring the overall level of pollutants within the liquid. It has been found that the level of light emitted from a sample will vary depending upon the total level of pollutants within the water sample. Thus a measurement of the light emission between a sample placed within the luminometer compared to the level of transmission from a reference example (deionized water) can provide an accurate indication of the total level of pollutants within the water sample. The test can thus give an overall level of pollutants immediately. This is of particular importance where there has been an accident causing a spillage of pollutants into a water course or where a temporary drinking water supply has been located but requires testing for contamination before use.

Portable light detectors differ from laboratory based equipment as they must function in a low power regime. This results in the detectors requiring different detection technology to laboratory based instruments due to the low power consumption required in a portable instrument. For example, typically a laboratory instrument will use a photo multiplier as the sensor, but such a high powered device is not suitable for use in a portable apparatus which will alternatively use a diode sensor or the like.

Portable apparatus also has to function reliably over a far greater range of climatic conditions. The instruments must also be robust due to the likelihood of accidental knocks which occur during field use.

The present invention seeks to provide a portable light detector suitable for prolonged used in exterior environments.

According to the present invention there is provided a portable light detector comprising a housing containing a detector means arranged to measure light emission from a sample, the housing having a port and a lid movable between a normal position where the port is covered and an open position where the port is uncovered for sample introduction, the lid comprising an opaque member arranged to permanently prevent light transmission through the lid to the detector means when the lid is in said normal position. The light detectors of the present invention require that no light is transmitted through the port when measurements are taken. It has been found that in previous detectors, that the enclosures tend to allow some transmission of light into the detector thereby providing inaccurate results. In some cases, the lid of the enclosure has been coated, e.g. with a paint to try and reduce light transmission, but over time such a coating does not reliably prevent transmission of light. The present invention has thus incorporated a lid with a member arranged to permanently prevent transmission of light through the lid. This member must be scratch-resistant and formed from a material which does not optically degrade with time to allow light transmission. The provision of the permanently opaque member greatly increases the accuracy of the light detector and the reliability of results taken therefrom.

Preferably, the housing comprises a plastics material. This has clear advantages in the cost of production per unit. Preferably the plastics materials is nylon 6,6 or polypropylene. Advantageously, these materials are very hard wearing and resistant to chemical or biochemical attack. The housing will normally be molded completely from the plastics material.

Preferably the lid is permanently retained within the housing. This reduces the likelihood of damage to the lid and the possibility of the lid being lost when samples are being inserted. For example, the lid may be hingedly mounted on a housing which allows full access to the port whilst retaining the lid.

The opaque member may be the whole lid, but preferably it comprises an insert thereinto. Advantageously the opaque member may comprise a metal, such an aluminium laminar. For example, where the aluminium laminar is an insert, this can be molded within the plastics shell of the lid. Although the metal may become scratched in use, normal use will not cause scratches that actually extend all the way through the metal laminar and so in normal use the opaque qualities of the insert are maintained.

The port will normally include a sample holder arranged to maintain the position of the sample relative to the detector means. The sample will normally be placed in a cuvette or similar and the sample holder will hold the cuvette in a pre-arranged geometry to the detector means.

Advantageously this sample holder is removable from the port. This allows cleaning of the detector means and port.

Advantageously a seal is formed between the port and the lid, for example between the sample holder and the lid. This seal prevents contamination of the port by grit or the like. The seal also prevents light emission between the lid and the port when the lid is in the normal position.

The portable detector of the present invention must of course be operable from a power supply which is a battery pack or rechargeable units, i.e. not only powerable through a mains electric supply. It is preferred for the power supply to be internal to the portable detector. The internal supply is advantageously located in a compartment which is isolated “optically” and physically from the detector means. This prevents contamination of the interior of the housing when changing batteries.

The detector means normally comprises an emitter means and a sensor means:

The sensor means will normally comprise a primary detector diode. It is preferred to use diode sensors as these are low power devices.

Preferably the sensor means further includes a blind detector diode, the sensor means being arranged to compensate for external conditions by adjusting the output of the primary detector diode by the output of the blind detector diode. Sensor diodes are prone to drift through temperature change. Thus in a portable detector which may be used over a wide of range of temperature e.g. −20° C. to +50° C., a diode sensor will often allow the zero measurement point of the sensor to drift to such a degree that full measurement of a sample is no longer possible. For example a diode sensor may typically have a 2.5V measurement range for measuring instant light. Temperature variation may shift the zero point of the measurement range by say 2V. This only allows a small region of the possible range to be measured when the voltage has drifted. This may often compromise proper measurement of a sample when the detector is being used in extreme temperature conditions. The use of the blind detector diode allows for correction of the reference voltage so that detection range is fully available in all temperature conditions. Such correction is not possible using a single detector.

The primary detector diode and the blind detector diode are preferably matched to produce substantially similar output over a wide range of climatic conditions. In this way the components are specifically selected so that the correction provided by the blind detector diode allows accurate adjustment of the detector. Diodes are matched by testing a range of diodes prior to assembly of the detector and selecting a pair of diodes that have been shown to respond similarly over different climatic conditions.

The emitter means normally comprises a light emitting diode (LED) as this is a relatively low powered light source. The light emitting diodes tend to vary their output light depending upon the external temperature. Preferably, the emitter means includes a feedback circuit arranged to ensure that the LED provides a constant level of light emission. The LED is provided with a detector which measures the level of light output directly from the LED. The LEDs are known that include such a detector attached thereto. The feedback design includes a very stable reference voltage which allows a feedback circuit to operate through a zero drift chopper amplifier so that the light output from the LED is constant regardless of temperature. This also overcomes the problem that LEDs tend to vary (reduce) output light with age. The power to the LED being increased as the LED gets older to maintain actual light output.

Preferably the detector is arranged to recalibrate for each sample measurement. This can be displayed graphically to the user so that the user is informed that the machine is working properly before each measurement. This is clearly important where the detector is used for water samples to see if they are suitable for drinking. If for example the detector was not working correctly, and a user relied upon an incorrect measurement, this could have potentially serious health impact upon a person who relied upon the incorrect results.

The detector means will normally operate from a power supply supplying less than 12V. It is preferred for the voltage to be less than 5V and advantageously may be as low as 3.2V. In this way the corresponding electronics circuitry within the detector must of course then be of particularly low power requirements. The low voltage regime allows for a long life of the power supply in the field.

The housing is normally designed to be impermeable to chemical and biochemical agents. This is important where the detector will be used in potentially adverse environments or for measuring measurements of particularly toxic agents.

It is preferred for the components internal to the housing to be mounted in a shock resistant manner. For example the printed circuit boards and display may be on rubber mounts. This reduces the breakage due to dropping when in use in the field.

The detector is preferably a luminometer arranged for measuring chemiluminescence or bioluminescence.

The detector advantageously further includes a memory means for storing results.

The detector advantageously further includes a communications port for communicating with external devices.

Preferably, the detector is arranged with the communications port arranged to transfer results stored in the memory means to an external storage device.

According to a second aspect of the present invention there is provided a kit including a detector of the first aspect of the invention and associated reagents for conducting the measurements. The kit may preferably further include a case for carrying the luminometer and reagents.

According to a third aspect of the present invention there is provided a kit including a detector of the first aspect of the invention and software, wherein the software is suitable for loading on to a computer to enable downloading of results from the detector.

Preferred embodiments of the present invention will now be described with reference to the accompanying drawings, in which:

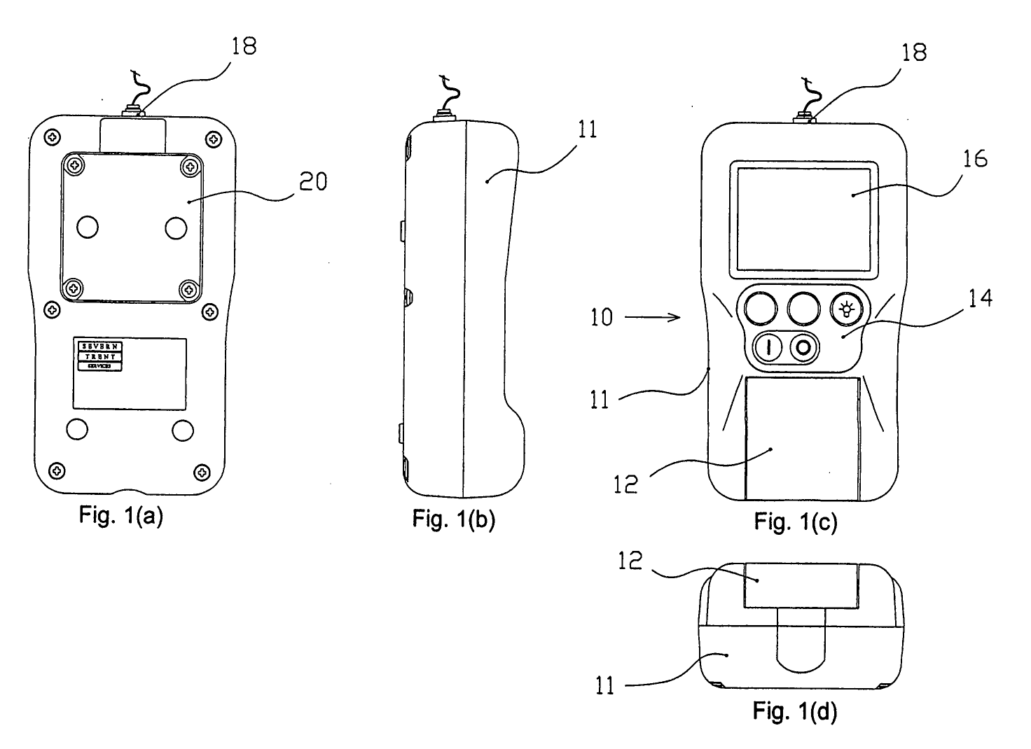

FIG. 1 shows a light detector according to the present invention;

FIG. 1A is a rear view;

FIG. 1B is a side view;

FIG. 1C is a front view, and

FIG. 1D is a bottom view;

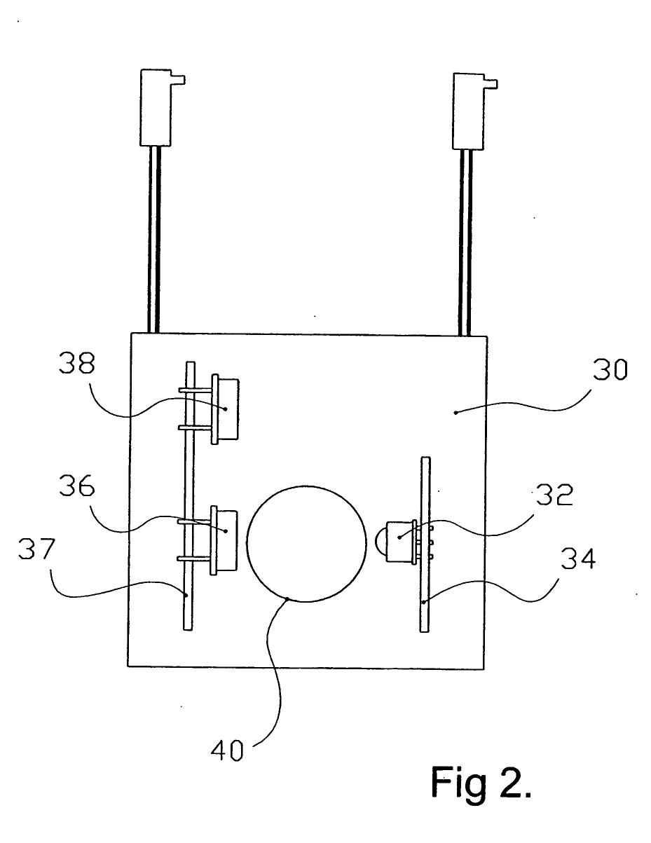

FIG. 2 is schematic layout of the detection means;

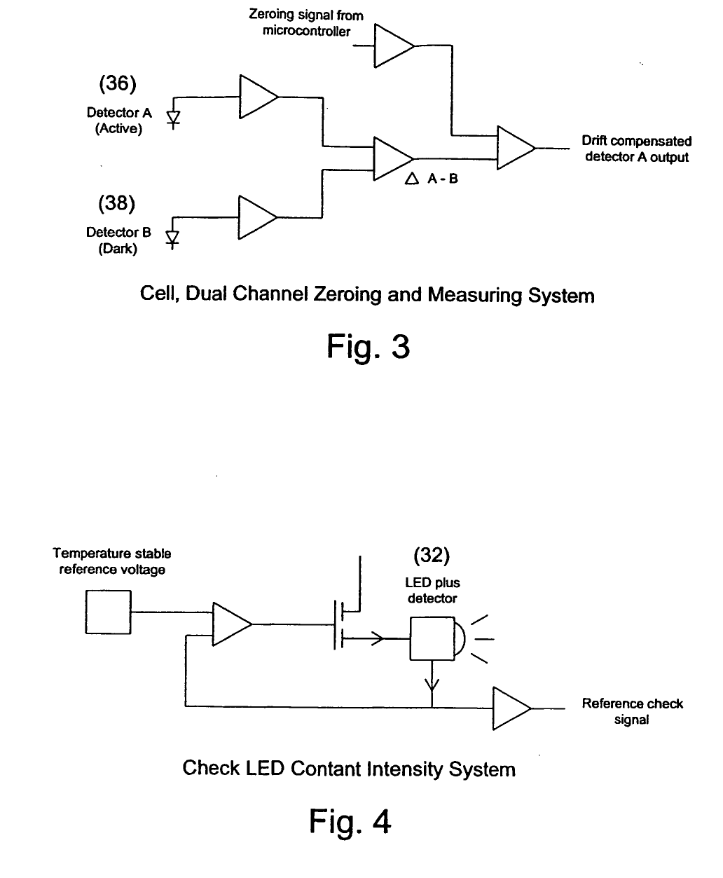

FIG. 3 is a schematic diagram of the illustrated embodiment;

FIG. 4 is a schematic diagram of the emitter circuit of the illustrated embodiment;

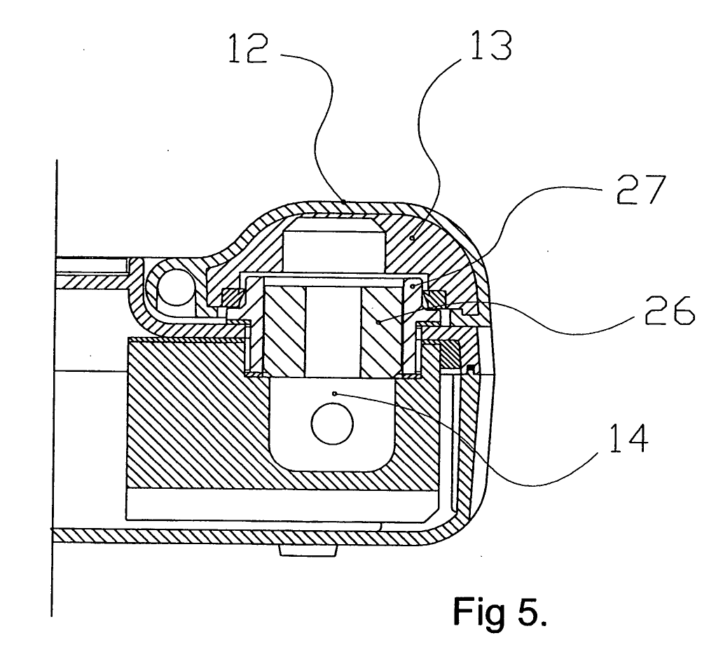

FIG. 5 is a cross-sectional partial view through the lid/port of FIG. 1;

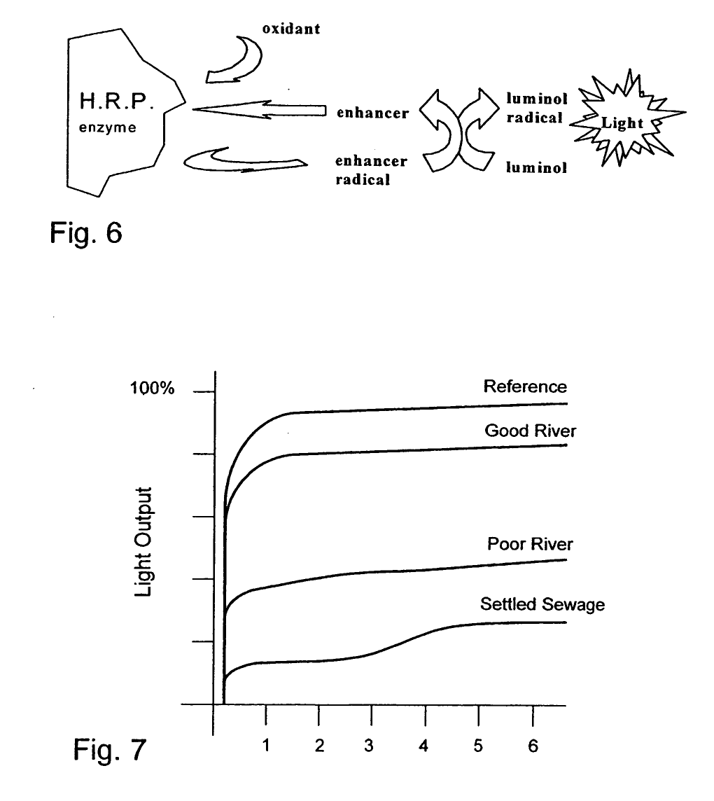

FIG. 6 is an illustration of the assay according to a preferred embodiment of the present invention;

FIG. 7 is a graph showing results taken from a test using the detector according to the present invention; and

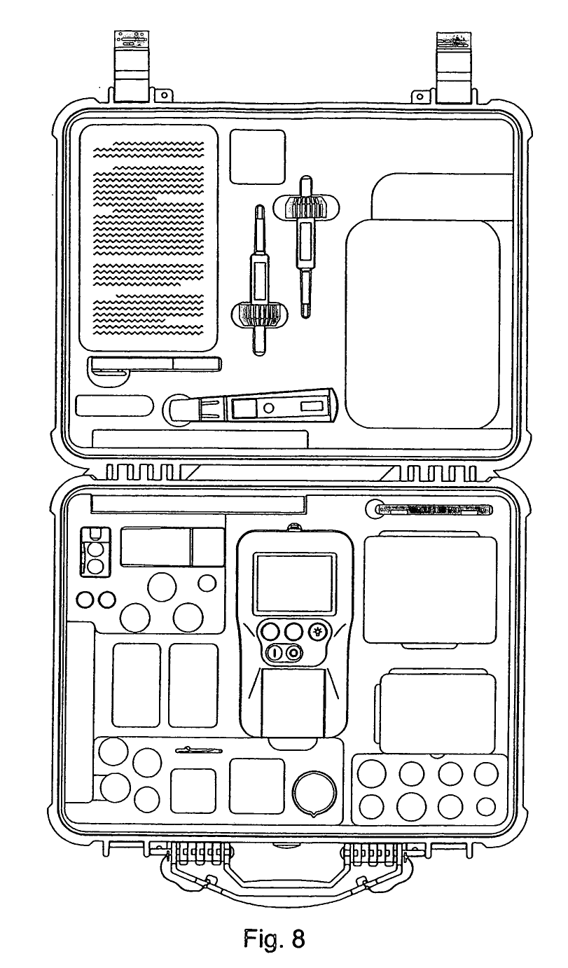

FIG. 8 is a kit according to a preferred embodiment of the present invention.

The light detector 10 according to the present invention is best shown in FIG. 1. The detector 10 is housed in housing 11. The detector 10 of the present invention is designed for a wide operating temperature range of −20° C. to +50° C.

The housing 11 has a lid 12 which is hingedly retained on the housing 11. The lid 12 is shown in its normal position and is movable to an open position (not shown) which exposes a port 24 (FIG. 5). The detector 10 has a control panel 14 on which are located the control buttons for the detector. The detector 10 has a display panel 16 which in the illustrated embodiment is an LCD which can graphically show the results obtained.

A communications port 18 is provided at the top of the detector. The housing 11 is a two part housing which is screwed together as shown best in FIGS. 1A and 1B. The rear of the detector includes panel 20 which comprises a cover to the battery enclosure located on the rear of the housing. The battery enclosure is isolated from the rest of the detector to prevent ingress of dust, water or the like.

The detector means 30 is located under the lid 12 within the housing 11. FIG. 2 shows a schematic representation of the layout of the detection means 30. The emitter means comprises an LED 32 mounted on an emitter control circuit board 34.

The sensor means comprises a primary diode detector 36 mounted on a sensor circuit board 37 which also has a blind diode detector 38 mounted thereupon. The sensor means is operated so that the blind diode detector 38 compensates for temperature drift thus providing a constant relative zero voltage for the sensor means as shown in FIG. 3. In the detector 10 the zero voltage is taken as being AA-B. This relative zero can be used with the two diodes which otherwise would not be possible using a single diode. Thus the full voltage range measurement is provided by the detector 10 of the present invention regardless of external temperature variation or other climatic conditions.

The two diode 36, 38 are selectively chosen for each particular detector 10. The outputs of the diodes are measured with temperature prior to installation. The detectors 36, 38 are then chosen by having near identical outputs over a wide range of temperature. The sensor means of the present invention could be used in portable or non-portable detectors.

The emitter means includes a feedback signal which is schematically represented in FIG. 4. A very temperature stable reference voltage is allied and this is used to ensure that the light emitted by the LED remains constant with temperature and age of the LED 32. The emitter means can be used in portable or non-portable instruments.

Whilst the dual detector diode method used in the measurement side of the luminometer cell provides the measurement signal of the luminescence of the sample under test, the integrity of this signal is vital to ensure reliable results. The LED emitter is used as a substitute light source to verify the cell integrity before taking a measurement, the operation of the luminometer is such that upon instigating a measurement cycle, the following actions are carried out, all prior to opening the cell and inserting sample:

1) The measurement cell output is automatically adjusted to zero;

2) The temperature stable reference voltage from the LED board is measured to verify the accuracy of the luminometer analogue to digital converter;

3) The check LED is turned on, and the closed loop control voltage from the LED board is measured to verify that the LED is on and within a acceptable intensity band;

4) The output from the measurement cell is verified to be within acceptable limits, and

5) The check LED is turned off.

Only when the above checks have been successfully completed, ensuring the integrity of the measurement cell will an actual measurement of the sample be carried out.

A sample is input through the port under the lid 12 when the lid 12 have been moved to its open position and the sample is retained at position 40 (FIG. 2).

The port 24 is formed with a sample holder insert 26. The sample holder insert 26 is sized to hold the cuvette containing a sample. The sample holder insert 26 sits within the cell face fitting 27 so that it can be removed for cleaning purposes. The top surface of the cell face fitting 27 forms a seal with the lid 12 in its closed position. The seal prevent ingress of contaminants into the port 24 and the detector means 30. The seal is also arranged to prevent light transmission into the detector means when the lid is in the normal (closed) position.

The lid 12 is formed from a molded plastics materials such as nylon 6,6 or polypropylene. The lid 12 includes aluminium casting about which the lid is molded. This aluminium casting 13 acts as an opaque barrier to light being transmitted through the lid 12. It has been found that plastics material alone often allows extremely low light transmission therethrough and thus the aluminium casting 13 is necessary to prevent all light transmission through the lid 12. In this application, no light transmission means no light measurable by the detector 10. The aluminium casting 11 is thick enough so as to be scratch-resistant in as far as that any scratches do not affect the opaque qualities thereof.

In this application permanently opaque means that the body prevents light transmission without degrading over time and with normal use, so being scratch-resistant and knock-resistant. In this regard this is contrasted with a painted or coated surface which may well be formed with minute areas which are uncovered and/or can be scratched in use. Thus a painted or coated surface does not form a permanently opaque coating/layer.

The housing 11 is normally made from a plastics material such as nylon 6,6 or polypropylene. Inside the housing 11 the various components will be mounted upon shock-resistant boards to assist in the robustness of the apparatus. This display 16 is therefore advantageously mounted on elastiomeric (rubber) mountings. The main printed circuit boards (not shown) are mounted on rubber grommets to afford the required shock resistance. The portable light detectors of the invention are operable independent of an external power supply and/or are battery powered. This is preferred for the electronics to operate at a voltage under 5V preferably 3.2V.

The illustrated embodiment is particularly suitable for conducting luminescence assays. For example a chemiluminescence assay. FIG. 5 shows a partial cross-section in the area of lid 12 of the detector 10. The lid 12 formed from nylon 6,6 and is hingedly mounted to the housing 11. The lid 12 has aluminium insert 13 which acts as a permanently opaque member. The lid 12 is molded around the aluminium casting to permanently retain the opaque member 13. Port 24 has sample holder 26 located therein. The sample holder 26 is removable from the port. The cell face fitting 27 forms a seal between the lid 12 when this is in its closed position (shown).

The detector 10 of the present invention is preferably used for measuring light emission from a liquid sample. The illustrated embodiment is shown as a luminometer. This has particular use in situations where there is a need to know the pollution levels within water. Pollutants are generally measured by the capacity to reduce available oxygen and therefore the related toxicity to life within the water. Free radicals contained in urine, faces, etc consume available oxygen reducing the amount for other living organisms such as plants and fish. Oxygen uptake is generally measured by the biological oxygen demand (BOD) and the chemical oxygen demand (COD). The BOD₅ test, although relatively simple, takes five days to yield the result. This is not only fairly costly but can also lead to difficulties in preventing further pollution and degradation of a water course. Alternatively, potentially toxic substances can be measured specifically by expensive laboratory based equipment such as chromatography or plasma apparatus providing one knows what contaminants are contained within the test sample.

The detector 10 of the present invention quickly and simply provides an accurate and immediate indication of water quality. The preferred embodiment of the present invention uses chemiluminescence. The technique has been used extensively in clinical and medical fields in diagnostic assays and in the determination of specific disease such as rheumatoid arthritis. The technique is based upon the reaction of luminol and an oxidant in the presence of a catalyst enzyme, such as horseradish peroxidase (HRP). When an enhancer is added such as p-iodophenol the light produced is stable and can be measured.

A schematic representation is shown in FIG. 6. Any free radical scavengers or antioxidants such as those contained in faeces or urine will interfere with this reaction thus reducing the light emission. Substances such as phenols, amines and heavy metals which attack the enzyme itself which will also reduce light output. When the light output is plotted over time characteristic curves are produced which enable rapid finger-printing.

FIG. 7 shows a theoretical results profile for settled sewage, poor river, good river and a reference based on the above reaction.

Further details of this type of assay can be found in EP 0 116 454. The present invention uses an advancement of the reactions described therein with some of the components being stabilised. Stabilization techniques are disclosed in PCT/GB89/01346 and PCT/GB91/00443. The reaction requires three reagents. Reagent (a) is luminol and p-iodophenol. Reagent (b) the oxidant and Reagent (c) the HRP enzyme.

The Test Method is a Two Stage Method:

(1) A de-ionized water reference is added to the sample tube. The three agents are added and the tube introduced into the luminometer. The light output trend is measured, displayed and the trace automatically stored.

(2) A sample is then added to the tube and the reagents added and the tube introduced into the luminometer. The light output trend is again measured, displayed and stored.

The percentage light inhibition of the sample is calculated and expressed as the integral of the light output of the reference over a given time. The percentage inhibition values are calculated and displayed. Alternatively or additionally the maximum light output from the sample divided by the maximum light output from the de-ionized reference can also be calculated as a measure of percentage light inhibition.

FIG. 7 gives an example thereof. In the detector 10 of the present invention, result curves can be recalled onto the display and overlaid for comparison with one another. The more polluted the river the higher percentage light inhibition. In addition, different types of pollutants give different light output trends. Relatively clean rivers tend to give similar trends to the reference but with a depressed maximum. Sewage on the other hand gives a characteristic S-shaped curve.

A wide range of water quality samples have been measured. This using the above technique. This has been compared with the BOD₅ and COD tests. The correlation between the chemiluminescence test and (1) the BOD₅ between 0-300 mg/1 as oxygen was 0.91 and (2) over 0.96 COD between 20-600 mg/1 as oxygen. Thus the detector 10 of the present invention provides a portable technique for conducting the measuring water quality.

The detector of the present invention includes a communications port 18. The detector also has a memory circuit. The memory is designed to store at least 50 sample data. This can be downloaded via the communication port to a computer. If preferred, the detector is sold as a kit together with the necessary software to enable this downloading.

The reagents for the assay are often also sold together with the luminometer to form a kit. The kit is often sold as a case. A full kit is shown in FIG. 8. The reagents need to be stable for at least several months. Stabilization of reagents is accomplished as described in the above two International Applications.

Generally, the present invention provides a portable luminometer for detecting very low light levels. The detector includes a sensor which is arranged to measure light emission from a sample contained in a housing of the detector. The sample is input through a port having a lid. The lid includes a member arranged to prevent the transmission of all exterior light to the sensor when the sample is being measured.

1. A portable light detector comprising a housing containing a detector means arranged to measure light emission from a sample, the housing having a port and a lid movable between a normal position where the port is covered and an open position where the port is uncovered for sample introduction, the lid comprising an opaque member arranged to permanently prevent light transmission through the lid to the detector means when the lid is in said normal position, wherein components internal to the housing are mounted-in a shock-resistant manner.

2. The detector according to claim 1, wherein the housing comprises a plastics material

3. The detector according to claim 2, wherein the plastics material is nylon 6,6 or polypropylene.

4. The detector according to either one of claims 2 or 3, wherein the housing consists of said plastics material.

5. The detector according to any one of the preceding claims, wherein the lid is retained in said housing.

6. The detector according to claim 5, wherein the lid is hingedly mounted on the housing.

7. The detector according to any one of the preceding claims, wherein the opaque member comprises an insert.

8. The detector according to any one of the preceding claims, wherein the opaque member comprises a metal.

9. The detector according to any one of the preceding claims, wherein the port includes a sample holder.

10. The detector according to claim 9, wherein the sample holder is removable.

11. The detector according to any one of the preceding claims, wherein the port forms a seal with the lid in the normal position.

12. The detector according to any one of the preceding claims, further including an internal power supply which is located in a compartment of the housing isolated from the detector means.

13. The detector according to claim 12, wherein the internal power supply comprises an electrical cell, and/or electric batteries.

14. The detector according to any one of the preceding claims, wherein the detector means comprises an emitter means and a sensor means.

15. The detector according to any one of the preceding claims, wherein the sensor means comprises a primary detector diode.

16. The detector according to claim 15, wherein the sensor means further includes a blind detector diode, the sensor means being arranged to compensate for external conditions by adjusting the output of the primary detector diode by the output of the blind detector diode.

17. The detector according to claim 16, wherein the primary detector diode and the blind detector diode are matched to produce substantially similar output over a wide range of climatic conditions.

18. The detector according to any one of the preceding claims, wherein the emitter means comprises a light emitting diode (LED).

19. The detector according to claim 18, wherein the emitter means includes a feedback circuit arranged to ensure that the LED provides a constant level of light emission.

20. The detector according to any one of the preceding claims, wherein the detector is arranged to recalibrate before each sample measurement.

21. The detector according to any one of the preceding claims, wherein the detector means operates with a less than 12 volt range.

22. The detector according to claim 21, wherein the voltage is less than 5V, preferably 3.2V.

23. The detector according to any one of the preceding claims, wherein the housing is impermeable to nerve gas and/or chemical agents.

24. The detector according to any one of the preceding claims, wherein the shock resistant mountings comprise elastiomeric and/or rubber mounts.

25. The detector according to any of the preceding comprising a luminometer.

26. The detector according to any one of the preceding claims for measuring chemiluminescence and/or bioluminescence.

27. A detector according to any one of the preceding claims, wherein the detector includes memory means for storing results.

28. A detector according to any of the preceding claims, further including a communications port for communicating with external devices.

29. A detector according to claims 27 and 28, wherein the communications port is arranged to transfer the results stored in the memory to an external storage device.

30. A kit including a detector according to any one of claims 1 to 29 and reagents for conducting said measurement.

31. The kit according to claim 30, further including a case for carrying the detector and reagents.

32. A kit comprising the detector according to any one of claims 1 to 29 and software, wherein the software is suitable for loading on to a computer to enable downloading of results from the detector.

33. A detector as hereinbefore described with reference to and/or as illustrated by the accompanying drawings.

34. A kit as hereinbefore described with reference to and/or as illustrated by the accompanying drawing.
